(19) United States
(12) Patent Application Publication
(10) Pub. No.: US 2011/0035301 A1
(43) Pub. Date: Feb. 10, 2011

(54) TARGETED PRODUCT COMMUNICATION SYSTEM

(76) Inventor: Kerry Small, State College, PA (US)

Correspondence Address: Jagrut Patel, 61 Sayreville Blvd South, Sayreville, NJ, 08872, US

(21) Appl. No.: 12/534,855

(22) Filed: Aug. 4, 2009

(51) Int. Cl. G06Q 10/00; G06Q 90/00; G06F 17/30; G06F 15/16

(52) U.S. Cl. 705/28; 705/500; 709/204; 707/E17.014; 707/E17.044

(57) ABSTRACT

A method of tracking consumer purchases from the safety first financial instrument and method of notifying consumer about product recall advisory based on the consumer purchase history tracked by the safety first financial instrument. When consumer purchases product using safety first financial instrument, the purchased product information is added to the consumer purchase database. The consumer is notified when a product recall notice is posted for the registered products in consumer database using multitude of communication channels. Invention also discloses method of notifying consumers on the product recall notice posted on used products.

### FIELD OF INVENTION

The present disclosure relates generally to product recall, and more particularly, to methods and techniques for tracking consumer purchases from the safety first financial instrument and communicating product advisory alerts to the consumer.

### BACKGROUND

Product recall is employed when defect in the product is discovered typically after the product is shipped to the consumer. The manufacturers are obligated to report such findings to the consumer yet the manufacturers are limited in their ability to inform consumers about recall and other important information.

Manufacturers typically rely on mailing recall and other product related information to the consumers. The process is not only expensive, time consuming and cumbersome but its inefficient. Manufacturers only have about 10 to 15 percent of consumer's information in its database as most of the sales have been conducted using multitude of retail and distribution channels. Further, manufacturers have limited or no information about the consumers that have bought the product resold in the market. Information is further limited on food and other consumable produces.

One method that is currently practiced is to have consumers fill out a card with required information and mailed to the manufacturer or other designated entity. The process is time consuming and consumers don't typically go to the trouble of filling out such cards as the process is to be carried out manually by the end consumer. It is difficult to get consumers to give information unless manufacturer is willing to incentivize heavily.

Other method currently practiced by the manufacturers is to offer on-line product registration over the internet. Typically purchasers never go through the trouble of registering their purchases even if it means forfeiting warranty, rebates and other incentives outlined by manufacturer.

Other method currently practiced involves the transmittal of information to the consumer via mass media e.g. commercial radio, television, broadcast, etc. Such recall advertising can be complicated as the recipients that receive irrelevant recall and safety messages will start ignoring such warnings and eventually would ignore recall and safety messages that are relevant.

There is a need for improved method and system for seamless tracking of consumer purchases and notifying the consumer in event of product related updates such as recall, safety notices, upgrades, and the like.

### SUMMARY

A method of product recall system is disclosed. The product recall system includes method for tracking consumer purchase information from financial instrument, method of saving consumer purchase information in the consumer purchase database, method of receiving product related notice from manufacturer and other government and independent agencies, method of associating the received notice with the consumers that have purchased the product, and method of notifying the consumer about the product notice.

An aspect of product recall system is disclosed. The product recall system includes means for tracking consumer purchase information from financial instrument, means of saving consumer purchase information in the consumer purchase database, means of receiving product related notice from manufacturer and other government and independent agencies, means of associating the received notice with the consumers that have purchase the product, and means of notifying the consumer about the product notice.

Computer readable media is disclosed. The computer-readable media contains set of instructions for tracking consumer purchase information from financial instrument. The instructions include a routine to store consumer purchase information into consumer product database, a routine to receive and retrieve product related notice from manufacturer, government agencies and other independent organizations, a routine to associate the received notice with the consumers that have purchased the product, and routine of notifying the consumer about the product notice.

### BRIEF DESCRIPTION OF DRAWINGS

Aspects of the present invention are illustrated by the way of example, and not by the way of limitation, in the accompanying drawings wherein:

FIG. 1 is a block diagram illustrating high level overview of a safety first product recall system.

FIG. 2 is a block diagram illustrating high level overview of integration of safety first product recall system into manufacturer 100/retailer 102 sales and financial institutions 206.

FIG. 3 is a flow chart illustrating process for integrating safety first product recall system with payment and transaction processes.

FIG. 4 is a flow chart illustrating process for updating consumer product database.

FIG. 5 is a flow chart illustrating process of retrieving product notices 116/118 from manufacturer 100/retailer 102 and government agencies 106.

FIG. 6 is a flow chart illustrating process of querying consumer product database.

### DETAILED DESCRIPTION

The detailed description is set forth below in connection with the appended drawings are intended as a description of various embodiments of the invention and is not intended to represent the only embodiments in which the invention may be practiced. The detailed description includes specific details of the purpose of providing a thorough understanding of the invention. However, it will be apparent to those skilled in the art that the invention may be practiced without these specific details. In some instances, well-known structures and components are shown in the block diagram form in order to avoid obscuring the concepts of the invention.

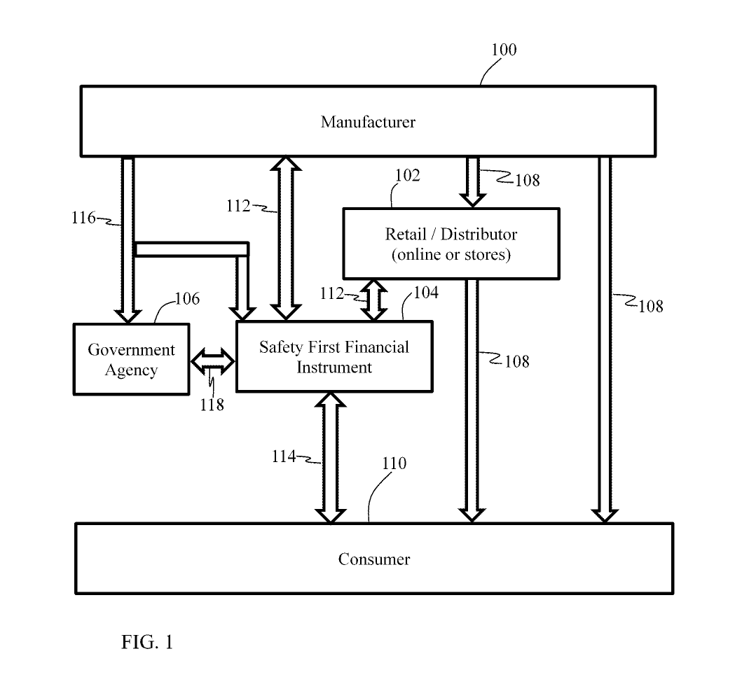

FIG. 1. is a block diagram illustrating high level overview of safety first product recall system. The consumer(s) 110 purchase product(s) 108 from Manufacturer 100 or from online or in-store retail or distributor 102. The consumer 110 makes payment 114 for the purchased product 108 using safety first financial instrument 104. The safety first financial instrument 104 retrieves product 108 information from manufacturer 100 or retailer/distributor 102 using process 112. The safety first financial instrument 104 saves the product 108 details in consumer product database. Manufacturer(s) 100 publishes product notice 116 to one or more government agencies 106, and in some cases such product notice 116 can be published directly to the safety first financial instrument 104. Further, the safety first financial instrument 104 continuously monitors 118 said government agencies 106 that maintain product notices 116 for any new notice posted by Manufacturer(s) 100. The safety first financial instrument 104 compares the published notice 116 against the consumer product database. The safety first financial instrument 104 notifies consumers 110 when a product notice 116 is published for one or more products 108 purchased by consumer 110.

The personnel skilled in the art may realize that the safety first financial instrument 104 is a process that may be initiated by, with no loss of generality or specificity, in any combination of, but not limited to, credit card, debit card, check, mobile phone payment system, checkout cart, online shopping chart, online/offline payment processing gateway, bank, etc.

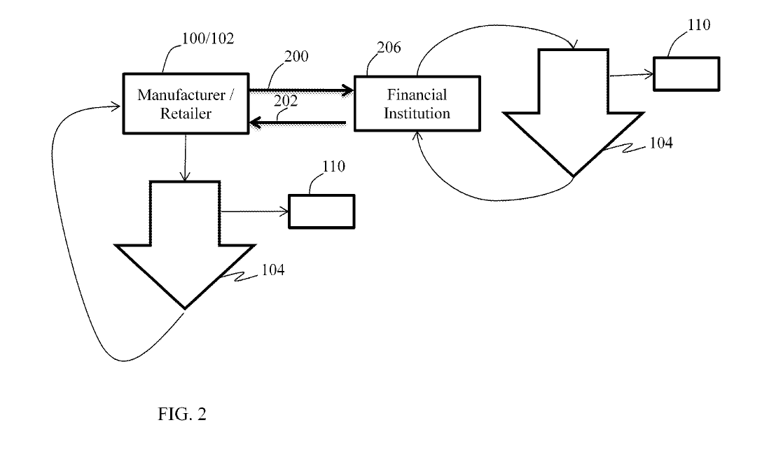

FIG. 2 is a block diagram illustrating high level overview of a safety first product recall system. The safety first financial instrument 104 may be a process that is embedded within Manufacturer 100, Retailer/Distributor 102 software processes. The safety first financial instrument 104 may be a process that is embedded within the financial institution 206 software processes. It shall be apparent to the personnel skilled in the art that the safety first financial instrument 104 that is embedded within Manufacturer 100 or Retailer 102 software processes can alert consumer 110 about the product notices 116 that are associated with the products 108 sold by that Manufacturer 100 or Retailer 102. Whereas the safety first financial instrument 104 that is embedded within the Financial Institution 206 can alert consumer 110 about the product notices 116 that are associated with any product 108 that is purchased from any Manufacturer 100 or Retailer 102. Further, it shall be apparent that both the safety first financial instrument 104 can simultaneously exist in both Manufacturer 100/Retailer 102 processes as well as the Financial Institution 206 processes and that the safety first financial instrument 104 process may be initiated by the payment processing request 200 and 202 by the Manufacturer 100/Retailer 102.

The personnel skilled in the art may realize that the Financial Institution 206 may be, with no loss of generality or specificity, in any combination of, but not limited to, credit card company, bank, cellular phone service provider, etc.

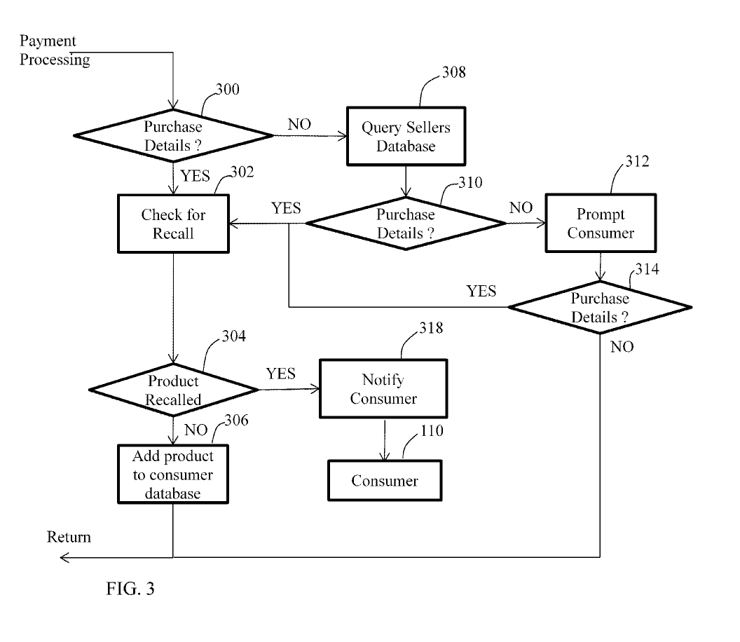

FIG. 3 is a flow chart illustrating process for integrating safety first financial instrument 104 with payment and transaction processes. The safety first financial instrument 104 process is initiated when payment or transaction processing request is received by Manufacturer 100 or Retailer 102 or the Financial Institution 206. If the details 300 for purchase 108 are available to the safety first financial instrument 104, the safety first financial instrument 104 checks 302 if there is any published product notice 116 on the purchased product 108. If 304 there are no product notices 116 found for the purchased product 104, the purchased product 116 details are added 306 to the consumer product database and the process is returned back to the normal processing else, the consumer 110 is notified 318 using one or more communication devices specified by the consumer 110. If the purchase details 300 for the purchased product 108 is not available with the payment or transaction process, the safety first financial instrument 104 queries the seller's database 308 to retrieve the product details. If the product details 310 is found for the purchased product 110 from the seller's database, the processing is resumed from check for recall 302 process onwards else the safety first financial instrument 104 prompts the consumer 312 to provide purchase details 314. On receiving product details 314, the processing is resumed from check for recall 302 process onwards else if the safety first financial instrument 104 is unable to get purchase details 314, it returns back for further downstream processing. It shall be apparent to the personnel skilled in the art that such processes can be an independent thread within the payment and transaction processing process as well as the program may terminate if there is no further downstream processing required.

The personnel skilled in the art may realize that purchase details 300 for the purchased product 108 may include but is not limited to, and in any parts or combinations of, Stock Keeping Unit (SKU), Universal Product Code (UPC), European Article Number (EAN), Global Trade Item Number (GTIN), Australian Product Number (APN), Electronic Product Code (EPC), Manufacturer Name, Product Name, Batch Code, etc.

The check for product recall 302 includes checking manufacturer 100, government and independent agency databases for any published notices 116/118 on the purchased products 108. Further any published notices 116/118 is communicated to the consumer 110 using notify consumer 318, which involves contacting consumer 110 using one or more communication devices such as but not limited to, and in any combinations of, cell phone call, voice mail, telephone call, SMS message, pager message, email, fax, postal message, website update, RSS, etc. Further, such product notice 116/118 may include messages related to warranty, recall, upgrades, updates, advertisement, instructions, etc.

Prompt consumer 312 requires consumer 110 provide purchase information. The consumer 110 may provide product details 108 using one or more communication devices such as cell phone, website, email, etc. It may be apparent to personnel skilled in the art that consumer 110 may scan the sales receipt and submit the details manually or automatically to safety first financial instrument 104. Further, the consumer can take picture of the product 108 such as but not limited to, bar code and submit it to the safety first financial instrument 104 via cell phone, internet, email, etc. The safety first financial instrument 104 can then process the submitted information and derive the product 108 information from the submitted information for further processing.

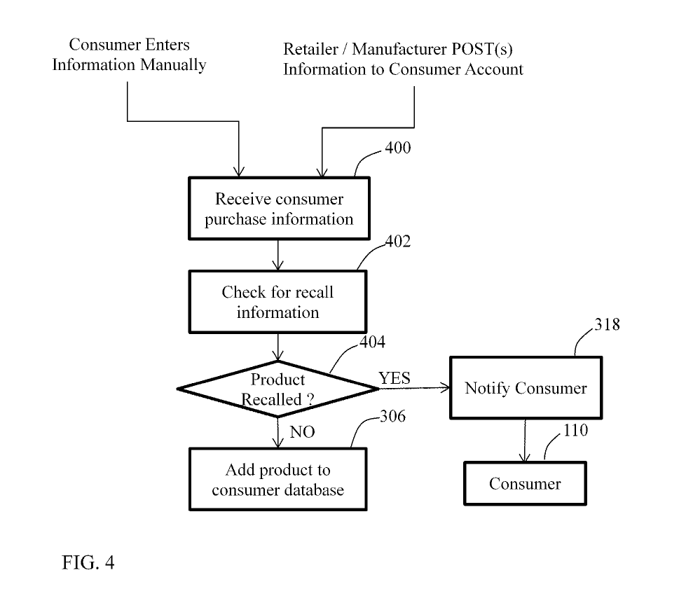

FIG. 4 is a flow chart illustrating process for updating consumer product database. The consumer 110 or the seller (manufacturer 100/retailer 102) may provide information to the safety first financial instrument 104 offline. The received information 400 is checked for recall 402 and if 404 there is an existing product notice 116/118 posted for the purchased product 108, the consumer 110 is notified 318 using one or more communication devices identified by the consumer 110.

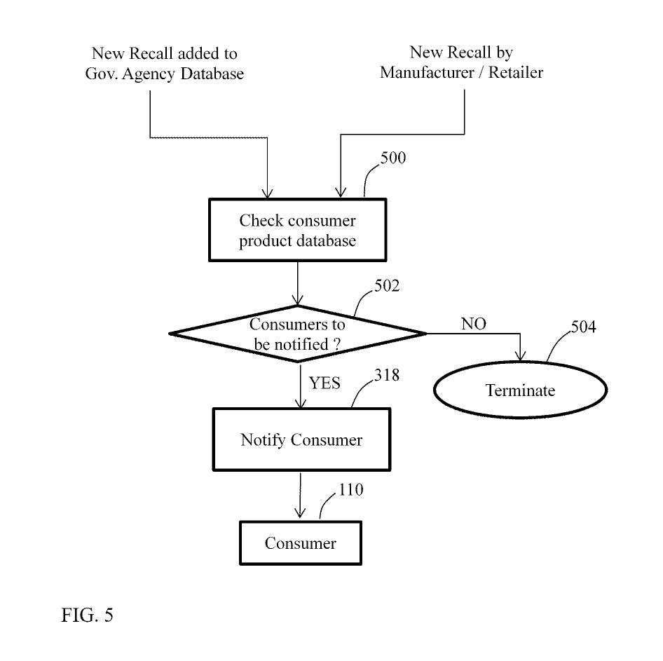

FIG. 5 is a flow chart illustrating process of retrieving product notices 116/118 from manufacturer 100/retailer 102 and government agencies/independent organizations 106. The information for product notices 116/118 is monitored continuously and when a new product notice 116/118 is published, the safety first financial instrument 104 checks the published notice 116/118 against the consumer product database 500. If 502 the consumer product database has matching entries corresponding to product notice 116/118, the consumer 110 is notified 318 about the product notice 116/118 else the process terminates without any further actions 504.

The personnel skilled in the art may realize that the safety first financial instrument 104 may retrieve product notices 116/118, with no loss of generality or specificity, in any combination of, but not limited to, OEM, Distributor, Retailer, Online Store, Online Database, TV, Radio, NHTSA, FDA, USEPA, USDA, Recall.gov, CPSC, Search Engine, etc.

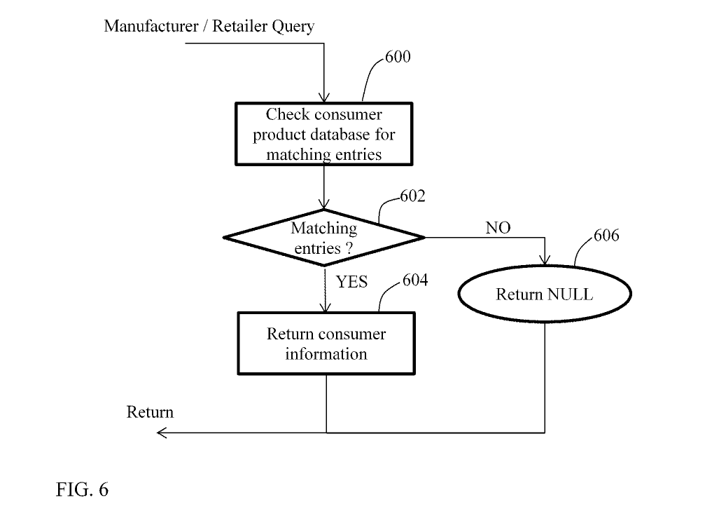

FIG. 6 is a flow chart illustrating process of querying consumer product database. The manufacturer 100/retailer 102 may query the consumer product database 600 for products purchased 108. Depending on the outcome of the matching process 602, response 604/606 is provided back to the querying entity. It shall be apparent to the personnel skilled in the art, that such information may be used by manufacturer 100/retailer 102 to directly contact the consumers 110 about the product defects and notices 116. Further such information may be used to promote competing products as well as for providing product related updates and instructions.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method for notifying consumer using safety first product recall system, comprising:
method for identifying consumer using safety first financial instrument,
method for linking consumer with purchase of products using safety first financial instrument;
method for continuously monitor various posted notices for purchased products using safety first financial instrument; and
method for notifying consumer on the posted notices on the purchased product using safety first financial instrument.

2. A method of claim 1, wherein the safety first financial instrument is a process initiated with credit card, debit card, check, mobile phone payment system, checkout cart, online shopping chart, online/offline payment processing gateway, bank account, etc.

3. A method of claim 1, wherein the safety first financial instrument is a software process with online retailer.

4. A method of claim 1, wherein the safety first financial instrument is a software process with a retailer store.

5. A method of claim 1, wherein the safety first financial instrument is a software process with financial institution.

6. A method in claim 5, wherein the financial institution is credit card companies, bank, cellular phone service provider, etc.

7. A method in claim 1, wherein the safety first financial instrument is software process with the manufacturer.

8. A method in claim 7, wherein the manufacture searches safety first financial instrument for consumers that have purchased a specific product for notification.

9. A method in claim 1, wherein the safety first financial instrument is software process on an Internet address.

10. A method in claim 9, wherein the consumer provides information of purchased product using cell phone, website, email, etc.

11. A method in claim 10, wherein the consumer provides information of the purchased product by sending the picture of the purchased product

12. A method in claim 11, wherein the consumer provides information of the purchased product by sending the picture of the barcode on the purchased product.

13. A method in claim 10, wherein the consumer provides information of the used products purchased and are notified for product notices.

14. A method in claim 1, wherein the safety first financial instrument links consumer with the product purchased using Stock Keeping Unit (SKU), Universal Product Code (UPC), European Article Number (EAN), Global Trade Item Number (GTIN), Australian Product Number (APN), Electronic Product Code (EPC), Manufacturer Name, Product Name, Batch Code, etc.

15. A method in claim 1, wherein the safety first financial instrument continuously monitors government databases for product notices

16. A method in claim 1, wherein the safety first financial instrument continuously monitors manufacturer databases for product notices

17. A method in claim 1, wherein the safety first financial instrument continuously monitors independent agency databases for product notices

18. A method in claim 1, wherein the safety first financial instrument notifies consumer of a product notice using cell phone call, voice mail, telephone call, SMS message, pager message, email, fax, postal message, website update, RSS

19. A method in claim 18, wherein the product notice can include messages related to warranty, recall, upgrades, updates, advertisement, instructions, etc.

20. Means for notifying consumer using Safety First Product Recall System, comprising:
means for identifying consumer using safety first financial instrument,
means for linking consumer with purchase of products,
means for continuously monitor various alerts posted for purchased products; and
means for notifying consumer on the alert posted on the purchased product.

21. Computer readable media for notifying consumer using Safety First Product Recall System, comprising:
a routine for identifying consumer using safety first financial instrument,
a routine for linking consumer with purchase of products,
a routine for continuously monitor various alerts posted for purchased products; and
a routine for notifying consumer on the alert posted on the purchased product.
